(19) United States
(12) Patent Application Publication
(10) Pub. No.: US 2016/0080953 A1
(43) Pub. Date: Mar. 17, 2016

(54) ADJUSTMENT OF ONE OR MORE OPERATIONAL PARAMETERS OF A SMALL CELL BASED ON SMALL CELL RELIABILITY

(71) Applicant: QUALCOMM Incorporated, San Diego, CA (US)

(72) Inventors: Yeliz TOKGOZ, San Diego, CA (US); Mehmet YAVUZ, San Diego, CA (US); Nathan Edward TENNY, Poway, CA (US); Christophe CHEVALLIER, San Diego, CA (US)

(21) Appl. No.: 14/693,481

(22) Filed: Apr. 22, 2015

Related U.S. Application Data
(60) Provisional application No. 62/050,356, filed on Sep. 15, 2014.

(51) Int. Cl. H04W 24/08; H04W 52/22; H04W 48/06; H04W 36/00

(52) U.S. Cl. CPC H04W 24/08; H04W 36/0083; H04W 52/228; H04W 48/06; H04W 84/045

(57) ABSTRACT

The disclosure is related to small cell base station power management within a wireless network. In an aspect, at least one metric related to operational and non-operational states of the small cell base station is determined, a reliability state of the small cell base station is determined based on the at least one metric related to the operational and non-operational states of the small cell base station, and one or more operational parameters of the small cell base station are adjusted based on the determined reliability state.

### CROSS-REFERENCE TO RELATED APPLICATIONS

The present Application for Patent claims the benefit of U.S. Provisional Application No. 62/050,356, entitled “POWER MANAGEMENT BASED ON SMALL CELL RELIABILITY,” filed Sep. 15, 2014, assigned to the assignee hereof, and expressly incorporated herein by reference in its entirety.

### INTRODUCTION

Aspects of this disclosure relate generally to telecommunications, and more particularly to adjusting one or more operational parameters of a small cell based on small cell reliability and the like.

Wireless communication systems are widely deployed to provide various types of communication content, such as voice, data, multimedia, and so on. Typical wireless communication systems are multiple-access systems capable of supporting communication with multiple users by sharing available system resources (e.g., bandwidth, transmit power, etc.).

In cellular networks, “macro cell” base stations provide connectivity and coverage to a large number of users over a certain geographical area. A macro network deployment is carefully planned, designed, and implemented to offer good coverage over the geographical region. Even such careful planning, however, cannot fully accommodate channel characteristics such as fading, multipath, shadowing, etc., especially in indoor environments. Indoor users therefore often face coverage issues (e.g., call outages and quality degradation) resulting in poor user experience.

To improve indoor or other specific geographic coverage, such as for residential homes and office buildings, additional “small cell,” typically low-power, base stations have recently begun to be deployed to supplement conventional macro networks. Neighborhood small cell base stations are typically deployed indoors to provide coverage for both indoor and outdoor users. These unplanned deployments require self-organizing network (SON) functionality in order to achieve scalable densification with robust performance.

Power management is an important SON feature that improves user performance by optimizing the coverage area of each small cell base station. For example, in very dense deployment scenarios, allowing all small cell base stations to transmit at the maximum transmit power may result in pilot pollution, which degrades both throughput and mobility performance for the users. With power management, some of the small cell base stations reduce their power to provide coverage in a smaller region, whereas some remain at high power and provide extended neighborhood coverage. Given that the high power small cell base stations are serving a larger area, their reliability directly impacts the network performance.

### SUMMARY

The following presents a simplified summary relating to one or more aspects and/or embodiments associated with the mechanisms disclosed herein for adjusting one or more operational parameters of a small cell base station within a wireless network. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

The disclosure is related to adjusting one or more operational parameters of a small cell base station within a wireless network. A method of adjusting one or more operational parameters of a small cell base station within a wireless network includes determining at least one metric related to operational and non-operational states of a small cell base station, determining a reliability state of the small cell base station based on the at least one metric related to the operational and non-operational states of the small cell base station, and adjusting the one or more operational parameters of the small cell base station based on the determined reliability state of the small cell base station.

An apparatus for adjusting one or more operational parameters of a small cell base station within a wireless network includes logic configured to determine at least one metric related to operational and non-operational states of a small cell base station, logic configured to determine a reliability state of the small cell base station based on the at least one metric related to the operational and non-operational states of the small cell base station, and logic configured to adjust the one or more operational parameters of the small cell base station based on the determined reliability state of the small cell base station.

An apparatus for adjusting one or more operational parameters of a small cell base station within a wireless network includes means for determining at least one metric related to operational and non-operational states of a small cell base station, means for determining a reliability state of the small cell base station based on the at least one metric related to the operational and non-operational states of the small cell base station, and means for adjusting the one or more operational parameters of the small cell base station based on the determined reliability state of the small cell base station.

A non-transitory computer-readable medium for adjusting one or more operational parameters of a small cell base station within a wireless network includes at least one instruction to determine at least one metric related to operational and non-operational states of a small cell base station, at least one instruction to determine a reliability state of the small cell base station based on the at least one metric related to the operational and non-operational states of the small cell base station, and at least one instruction to adjust the one or more operational parameters of the small cell base station based on the determined reliability state of the small cell base station.

Other objects and advantages associated with the mechanisms disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example mixed-deployment wireless communication system including macro cell base stations and small cell base stations.

FIG. 2 illustrates an example small cell base station with co-located radio components (e.g., LTE and Wi-Fi).

FIG. 3 illustrates a server in accordance with an embodiment of the disclosure.

FIG. 4 is a flow diagram illustrating an example method of small cell base station power management within a wireless network.

FIG. 5 is a simplified block diagram of several sample aspects of components that may be employed in communication nodes and configured to support communication as taught herein.

FIGS. 6 and 7 are simplified block diagrams of several sample aspects of apparatuses configured to support communication as taught herein.

FIG. 8 illustrates an example communication system environment in which the teachings and structures herein may be may be incorporated.

### DETAILED DESCRIPTION

The present disclosure relates generally to adjusting one or more operational parameters of a small cell base station based on small cell reliability and the like. In an aspect, at least one metric related to operational and non-operational states of a small cell base station is determined, a reliability state of the small cell base station is determined based on the at least one metric related to the operational and non-operational states of the small cell base station, and one or more operational parameters of the small cell base station are adjusted based on the determined reliability state of the small cell base station.

These and other aspects of the disclosure are provided in the following description and related drawings directed to various examples provided for illustration purposes. Alternate aspects may be devised without departing from the scope of the disclosure. Additionally, well-known aspects of the disclosure may not be described in detail or may be omitted so as not to obscure more relevant details.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., Application Specific Integrated Circuits (ASICs)), by program instructions being executed by one or more processors, or by a combination of both. In addition, for each of the aspects described herein, the corresponding form of any such aspect may be implemented as, for example, “logic configured to” perform the described action.

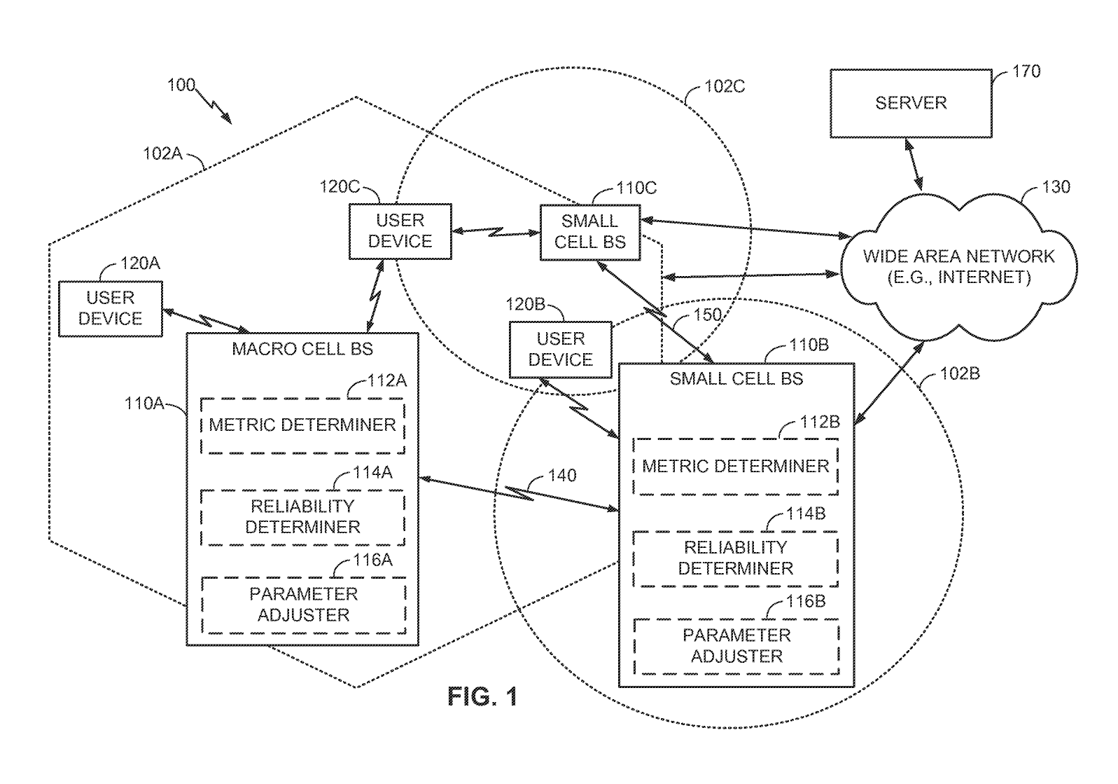

FIG. 1 illustrates an example mixed-deployment wireless communication system, in which small cell base stations are deployed in conjunction with and to supplement the coverage of macro cell base stations. As used herein, small cells generally refer to a class of low-powered base stations that may include or be otherwise referred to as femto cells, pico cells, micro cells, etc. The small cell base stations may be deployed to provide improved signaling, incremental capacity growth, richer user experience, and so on.

The illustrated wireless communication system 100 is a multiple-access system that is divided into a plurality of cells 102A-C and configured to support communication for a number of users. Communication coverage in each of the cells 102A-C is provided by a corresponding base station 110A-C, which interacts with one or more user devices 120A-C via DownLink (DL) and/or UpLink (UL) connections. In general, the DL connection corresponds to communication from a base station to a user device, while the UL connection corresponds to communication from a user device to a base station.

As will be described in more detail below, these different entities may be variously configured in accordance with the teachings herein to provide or otherwise support the adjustment of one or more operational parameters of a small cell based on small cell reliability, as discussed briefly above. For example, the macro cell base station 110A may include a metric determiner module 112A configured to determine at least one metric related to operational and non-operational states of a small cell base station, such as small cell base station 110B and/or 110C, a reliability determiner module 114A configured to determine a reliability state of the small cell base station 110B and/or 110C based on the at least one metric related to the operational and non-operational states of the small cell base station 110B and/or 110C, and a parameter adjuster module 116A configured to adjust one or more operational parameters of the small cell base station based on the determined reliability state.

Additionally, or alternatively, one or more of the small cell base stations 110 B and/or 110C (small cell base station 110B in the example of FIG. 1) may include a metric determiner module 112B configured to determine at least one metric related to operational and non-operational states of a small cell base station, such as small cell base station 110B and/or 110C, a reliability determiner module 114B configured to determine a reliability state of the small cell base station 110B and/or 110C based on the at least one metric related to the operational and non-operational states of the small cell base station, and a parameter adjuster module 116B configured to adjust one or more operational parameters of the small cell base station 110B and/or 110C based on the determined reliability state. The modules 112A-116A and 112B-116B are illustrated with dashed lines because they may be components of the macro cell base station 110A only, the small cell base station 110B only, or both the macro cell base station 110A and the small cell base station 110B.

Adjustment of one or more operational parameters of the small cell base station can be used to improve user experience if the reliability of a small cell base station (e.g., a high power small cell base station that is providing extended neighborhood coverage) cannot be guaranteed. Such a scenario may occur, for instance, if the owner of a small cell base station consistently unplugs the device during daytime to save energy. Consequently, the small cell base station would not be able to provide coverage during that time, which can lead to an inconsistent user experience in that region.

As used herein, the terms “user device” and “base station” are not intended to be specific or otherwise limited to any particular Radio Access Technology (RAT), unless otherwise noted. In general, such user devices may be any wireless communication device (e.g., a mobile phone, router, personal computer, server, etc.) used by a user to communicate over a communications network, and may be alternatively referred to in different RAT environments as an Access Terminal (AT), a Mobile Station (MS), a Subscriber Station (STA), a User Equipment (UE), etc. Similarly, a base station may operate according to one of several RATs in communication with user devices depending on the network in which it is deployed, and may be alternatively referred to as an Access Point (AP), a Network Node, a NodeB, an evolved NodeB (eNB), etc. In addition, in some systems a base station may provide purely edge node signaling functions; while in other systems, it may provide additional control and/or network management functions.

Returning to FIG. 1, the different base stations 110A-C include an example macro cell base station 110A and two example small cell base stations 110B, 110C. The macro cell base station 110A is configured to provide communication coverage within a macro cell coverage area 102A, which may cover a few blocks within a neighborhood or several square miles in a rural environment. Meanwhile, the small cell base stations 110B, 110C are configured to provide communication coverage within respective small cell coverage areas 102B, 102C, with varying degrees of overlap existing among the different coverage areas. In some systems, each cell may be further divided into one or more sectors (not shown).

Turning to the illustrated connections in more detail, the user device 120A may transmit and receive messages via a wireless link with the macro cell base station 110A, the message including information related to various types of communication (e.g., voice, data, multimedia services, associated control signaling, etc.). The user device 120B may similarly communicate with the small cell base station 110B via another wireless link, and the user device 120C may similarly communicate with the small cell base station 110C via another wireless link. In addition, in some scenarios, the user device 120C, for example, may also communicate with the macro cell base station 110A via a separate wireless link in addition to the wireless link it maintains with the small cell base station 110C.

As is further illustrated in FIG. 1, the macro cell base station 110A may communicate with a corresponding wide area or external network 130, via a wired link or via a wireless link, while the small cell base stations 110B, 110C may also similarly communicate with the network 130, via their own wired or wireless links. For example, the small cell base stations 110B, 110C may communicate with the network 130 by way of an Internet Protocol (IP) connection, such as via a Digital Subscriber Line (DSL, e.g., including Asymmetric DSL (ADSL), High Data Rate DSL (HDSL), Very High Speed DSL (VDSL), etc.), a TV cable carrying IP traffic, a Broadband over Power Line (BPL) connection, an Optical Fiber (OF) cable, a satellite link, or some other link.

The network 130 may comprise any type of electronically connected group of computers and/or devices, including, for example, Internet, Intranet, Local Area

Networks (LANs), or Wide Area Networks (WANs). In addition, the connectivity to the network may be, for example, by remote modem, Ethernet (IEEE 802.3), Token Ring (IEEE 802.5), Fiber Distributed Datalink Interface (FDDI) Asynchronous Transfer Mode (ATM), Wireless Ethernet (IEEE 802.11), Bluetooth (IEEE 802.15.1), or some other connection. As used herein, the network 130 includes network variations such as the public Internet, a private network within the Internet, a secure network within the Internet, a private network, a public network, a value-added network, an intranet, and the like. In certain systems, the network 130 may also comprise a Virtual Private Network (VPN).

A server 170 is shown as connected to the network 130. The server 170 can be implemented as a plurality of structurally separate servers, or alternatively may correspond to a single server. As will be described below in more detail, the server 170 may be, or may include, a Central Small Cell Controller configured to support one or more communication services (e.g., adjustment of one or more operational parameters of a small cell base station within a wireless network, etc.) for base stations that can connect to the server 170 via the network 130.

The macro cell base station 110A and/or either or both of the small cell base stations 110B, 110C may be connected to the network 130 using any of a multitude of devices or methods. These connections may be referred to as the “backbone” or the “backhaul” of the network, and may in some implementations be used to manage and coordinate communications between the macro cell base station 110A, the small cell base station 110B, and/or the small cell base station 110C. In this way, as a user device moves through such a mixed communication network environment that provides both macro cell and small cell coverage, the user device may be served in certain locations by macro cell base stations, at other locations by small cell base stations, and, in some scenarios, by both macro cell and small cell base stations.

For their wireless air interfaces, each base station 110A-C may operate according to one of several RATs depending on the network in which it is deployed. These networks may include, for example, Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. The terms “network” and “system” are often used interchangeably. A CDMA network may implement a RAT such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a RAT such as Global System for Mobile Communications (GSM). An OFDMA network may implement a RAT such as Evolved UTRA (E-UTRA), IEEE 802.11, IEEE 802.16, IEEE 802.20, Flash-OFDM®, etc.

These systems are often deployed in conformity with specifications such as Third Generation Partnership Project (3GPP), 3GPP Long Term Evolution (LTE), Ultra Mobile Broadband (UMB), Evolution Data Optimized (EV-DO), Institute of Electrical and Electronics Engineers (IEEE), etc. For example, UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3GPP2). These documents are publicly available.

The macro cell base station 110A may communicate with the small cell base stations 110B, 110C in its macro cell coverage area 102A (illustrated in FIG. 1 as small cell base stations 110B and 110C) via a common RAT (e.g., CDMA, GSM, LTE, etc.). For example, the macro cell base station 110A and the small cell base station 110B may communicate with each other over a communication link 140. The communication link 140 may be an air interface utilizing an RAT common to both the macro cell base station 110A and the small cell base station 110B, such as an LTE air interface. Additionally, the small cell base stations 110B and 110C may be able to communicate with each other over a common RAT if their coverage areas overlap. For example, the small cell base stations 110B and 110C may communicate with each other over communication link 150. The communication link 150 may be an air interface utilizing an RAT common to both the small cell base station 110B and the small cell base station 110C, such as an LTE air interface. Alternatively, or additionally, they may be able to communicate with each other over network 130.

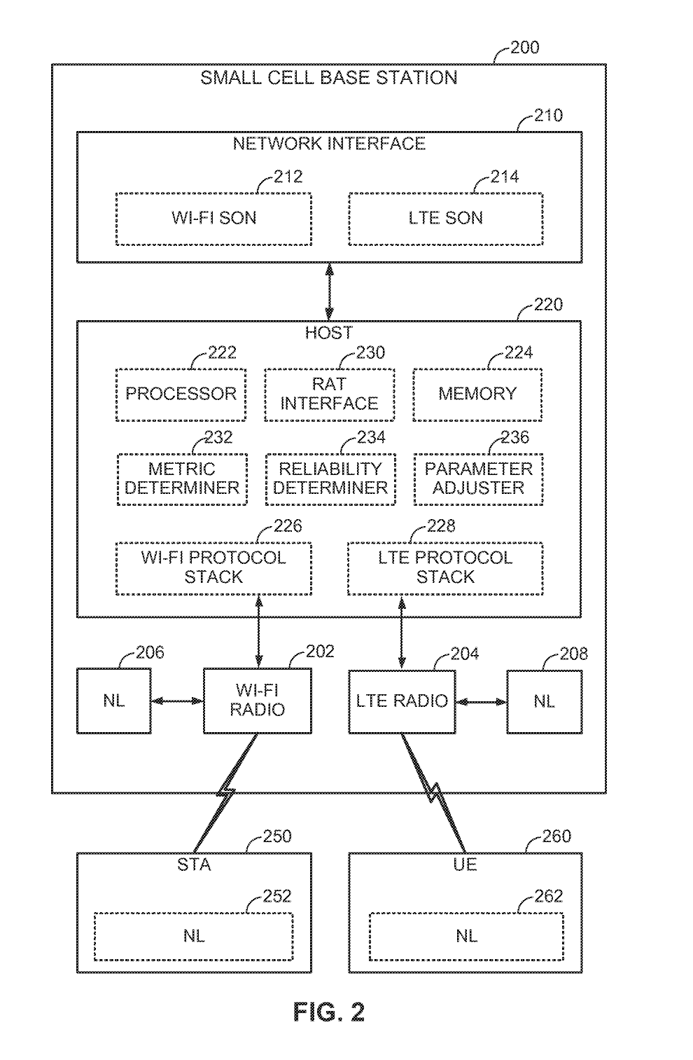

FIG. 2 illustrates an example small cell base station 200 with co-located radio components. The small cell base station 200 may correspond, for example, to one of the small cell base stations 110B, 110C illustrated in FIG. 1. In this example, the small cell base station 200 is configured to provide a Wireless Local Area Network (WLAN) air interface (e.g., in accordance with an IEEE 802.1 lx protocol) in addition to a cellular air interface (e.g., in accordance with an LTE protocol). For illustration purposes, the small cell base station 200 is shown as including Wi-Fi radio component/module (e.g., transceiver) 202 co-located with an LTE radio component/module (e.g., transceiver) 204.

As used herein, the term co-located (e.g., radios, base stations, transceivers, etc.) may include in accordance with various aspects, one or more of, for example: components that are in the same housing; components that are hosted by the same processor; components that are within a defined distance of one another; and/or components that are connected via an interface (e.g., an Ethernet switch) where the interface meets the latency requirements of any required inter-component communication (e.g., messaging).

Returning to FIG. 2, the Wi-Fi radio 202 and the LTE radio 204 may perform monitoring of one or more channels (e.g., on a corresponding carrier frequency) to perform various corresponding operating channel or environment measurements (e.g., CQI, RSSI, RSRP, or other RLM measurements) using corresponding Network/Neighbor Listen (NL) modules 206 and 208, respectively, or any other suitable component(s).

The small cell base station 200 may communicate with one or more user devices via the Wi-Fi radio 202 and the LTE radio 204, illustrated as an STA 250 and a UE 260, respectively. Similar to the Wi-Fi radio 202 and the LTE radio 204, the STA 250 includes a corresponding NL module 252 and the UE 260 includes a corresponding NL module 262 for performing various operating channel or environment measurements, either independently or under the direction of the Wi-Fi radio 202 and the LTE radio 204, respectively. In this regard, the measurements may be retained at the STA 250 and/or the UE 260, or reported to the Wi-Fi radio 202 and the LTE radio 204, respectively, with or without any pre-processing being performed by the STA 250 or the UE 260.

While FIG. 2 shows a single STA 250 and a single UE 260, for illustration purposes, it will be appreciated that the small cell base station 200 can communicate with multiple STAs and/or UEs. Additionally, while FIG. 2 illustrates one type of user device communicating with the small cell base station 200 via the Wi-Fi radio 202 (i.e., the STA 250) and another type of user device communicating with the small cell base station 200 via the LTE radio 204 (i.e., the UE 260), it will be appreciated that a single user device (e.g., a smartphone) may be capable of communicating with the small cell base station 200 via both the Wi-Fi radio 202 and the LTE radio 204, either simultaneously or at different times.

As is further illustrated in FIG. 2, the small cell base station 200 may also include a network interface 210, which may include various components for interfacing with corresponding network entities (e.g., Self-Organizing Network (SON) nodes), such as a component for interfacing with a Wi-Fi SON 212 and/or a component for interfacing with an LTE SON 214. The small cell base station 200 may also include a host 220, which may include one or more general purpose controllers or processors 222 and memory 224 configured to store related data and/or instructions. The host 220 may perform processing in accordance with the appropriate RAT(s) used for communication (e.g., via a Wi-Fi protocol stack 226 and/or an LTE protocol stack 228), as well as other functions for the small cell base station 200. In particular, the host 220 may further include a RAT interface 230 (e.g., a bus or the like) that enables the Wi-Fi radio 202 and the LTE radio 204 to communicate with one another via various message exchanges.

As a further enhancement, the small cell base station 200 may be configured in accordance with the teachings herein to provide or otherwise support the adjustment of one or more operational parameters of a small cell base station based on small cell reliability, as discussed briefly above. For example, the small cell base station 200 may include a metric determiner module 232 (which may correspond to the metric determiner module 112B in FIG. 1) configured to determine at least one metric related to operational and non-operational states of a small cell base station, such as small cell base station 110B, 110C, and/or 200, a reliability determiner module 234 (which may correspond to the reliability determiner module 114B in FIG. 1) configured to determine a reliability state of the small cell base station based on the at least one metric related to the operational and non-operational states of the small cell base station, and a parameter adjuster module 236 (which may correspond to the parameter adjuster module 116B in FIG. 1) configured to adjust one or more operational parameters of the small cell base station based on the determined reliability state.

With these modules, the small cell base station 200, specifically, the metric determiner module 232, can monitor the amount of time it is operational versus the amount of time it is unavailable for service (e.g., powered down), as well as the number of times it changes state from operational to non-operational. Based on certain acceptable thresholds on these metrics, the small cell base station 200, specifically, the reliability determiner module 234, can decide whether it is a reliable node or not. For example, if the small cell base station 200 is powered off 30% of the time, it may not be a suitable cell for extended coverage. This decision can be provided as input to a power management algorithm implemented by the parameter adjuster module 236 to create a bias towards lower power settings in order to limit the impact of this unreliable node to a smaller coverage area.

Although illustrated as components of the small cell base station 200, the metric determiner module 232, the reliability determiner module 234, and the parameter adjuster module 236, implementing the power management algorithm may be executed by the small cell base station 200, a server in communication with the small cell base station 200 over, for example, the wide area network 130, such as server 170, or distributed across several small cell base stations. For example, when the small cell base station 200 reports measurements to the server and the server determines the small cell base station 200's power level, the small cell base station 200 may also report its reliability rating. The server can then take this reliability rating into consideration when determining the small cell base station 200's power level. The server may have the advantage of being connected to other small cell base stations that are near small cell base station 200, and thereby be able to coordinate the power levels of each of these small cell base stations to complement each other.

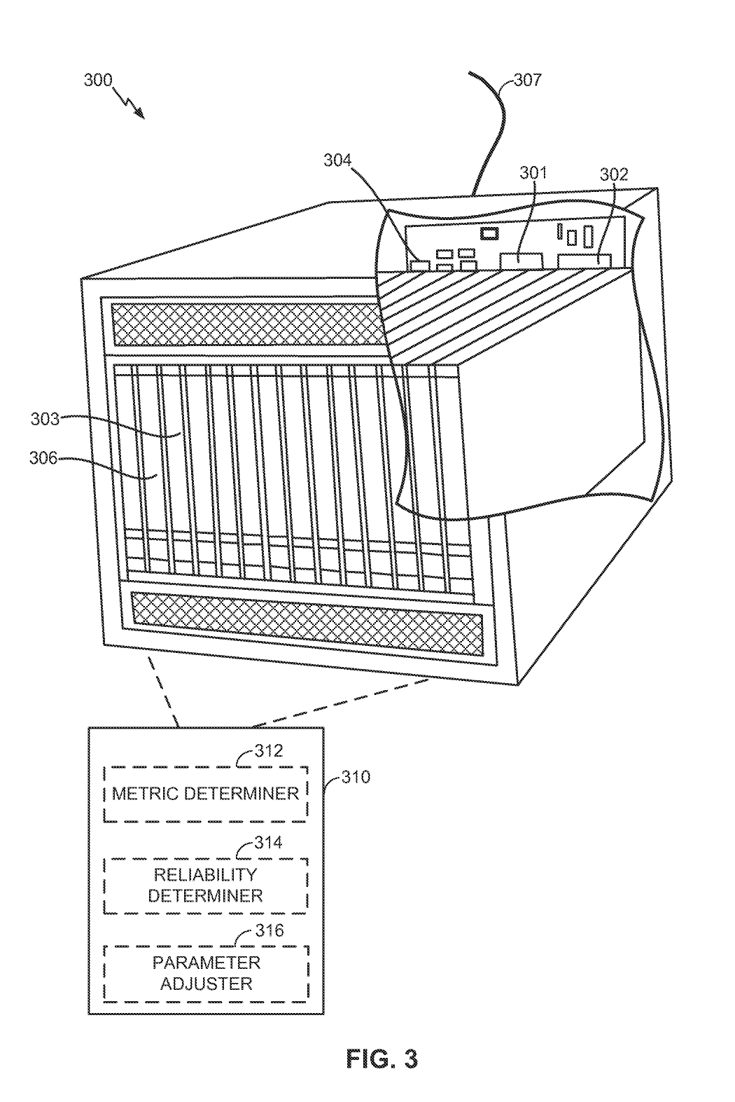

As noted above, the various embodiments may be implemented on any of a variety of commercially available server devices, such as server 300 illustrated in FIG. 3. In an example, the server 300 may correspond to one example configuration of the server 170 described above. In FIG. 3, the server 300 includes a processor 301 coupled to volatile memory 302 and a large capacity nonvolatile memory, such as a disk drive 303. The server 300 may also include a floppy disc drive, compact disc (CD) or DVD disc drive 306 coupled to the processor 301. The server 300 may also include network access ports 304 coupled to the processor 301 for establishing data connections with a network 307, such as a local area network coupled to other broadcast system computers and servers or to the Internet.

Where the server 300 corresponds to or includes a Central Small Cell Controller, the server 300 may include a platform 310. The platform 310 may be configured in accordance with the teachings herein to provide or otherwise support the adjustment of one or more operational parameters of a small cell base station, as discussed briefly above. For example, the platform 310 may include a metric determiner module 312 configured to determine at least one metric related to operational and non-operational states of a small cell base station, such as small cell base stations 110B, 110C, and/or 200, a reliability determiner module 314 configured to determine a reliability state of the small cell base station based on the at least one metric related to the operational and non-operational states of the small cell base station, and a parameter adjuster module 316 configured to adjust one or more operational parameters of the small cell base station based on the determined reliability state. The modules 312-316 of platform 310 may be stored in memory 303/306 and be executable by the processor 301, or may be hardware and/or firmware modules integrated into or coupled to the processor 301. The modules 312-316 are illustrated as optional (as indicated by the dashed lines) because the functionality described herein may be, but need not be, implemented by a server/Central Small Cell Controller.

Where the small cell base stations in a particular neighborhood deployment coordinate to set their power levels, they may also share their reliability ratings with each other. In that case, each small cell base station may set its power level also based on the reliability ratings of its neighbor small cell base stations. Alternatively, the small cell base stations in a neighborhood deployment may receive the measurements used to calculate reliability ratings from the other small cell base stations and calculate the corresponding reliability ratings themselves.

In addition to changing the power footprint of an unreliable small cell base station as described above, configuration actions related to SON functionality can be taken in response to the categorization of a small cell base station as “unreliable.” Where the power adjustment focuses on reducing pilot pollution directly, the following aspects are mainly directed to controlling the effects of unreliable small cell base stations on higher-layer procedures like measurement and mobility. A combination of these techniques (including power adjustment) could be used concurrently.

First, regarding interface relations, an unreliable small cell base station could be excluded from various configured relationships to neighboring cells (especially macro cells). For example, an unreliable small cell base station could be excluded from the neighbor relation table, blacklisted, and/or denied X2 connectivity (the backhaul LTE connection between base stations). Similarly, a macro cell or another small cell may determine that a sufficiently unreliable small cell neighbor will never be prepared for handover or used as a handover target, regardless of what UEs in the area may report.

In some cases, such as the neighbor relation table (NRT), these determinations can be made at a central SON server; in others, such as handover decisions, they can be viewed as more suitable for autonomous determination at the concerned macro cell and/or small cell. In principle, however, the location of the decision is orthogonal to the disclosure; any entity that in a particular network configuration has “authority” to make a particular decision in this area could use the reliability of a small cell base station as a criterion.

Second, regarding mobility and measurement parameters, as a way of avoiding handovers to unreliable small cell base stations, a base station (small or macro) can configure strong cell-specific offsets to bias UEs away from these cells. Other parameters, such as measurement thresholds and triggering criteria, may be adjusted as well, but are less likely to be useful except in specific deployment configurations (e.g., if unreliable small cell base stations were concentrated on a single frequency, a frequency-specific offset or different measurement configurations towards that frequency may help prevent spurious measurement reports and reselections).

Third, regarding a small cell base station's open/closed/hybrid status, since only open or hybrid small cell base stations will be used to share coverage with the macro network, it may be advantageous to force unreliable small cells to switch to closed (CSG) status. Since UEs already avoid CSGs unless they are members of the appropriate user group, a closed unreliable small cell base station will not attract public traffic from the other cells. As described further below, in a hybrid access mode, non-CSG UEs may be given limited access to the small cell base station only if sufficient resources are available for all CSG UEs currently being served by the small cell base station.

Note that, in addition to being commanded from elsewhere (e.g., a Central Small Cell Controller or Management Systems), this status could be controlled directly by the offending small cell base station itself

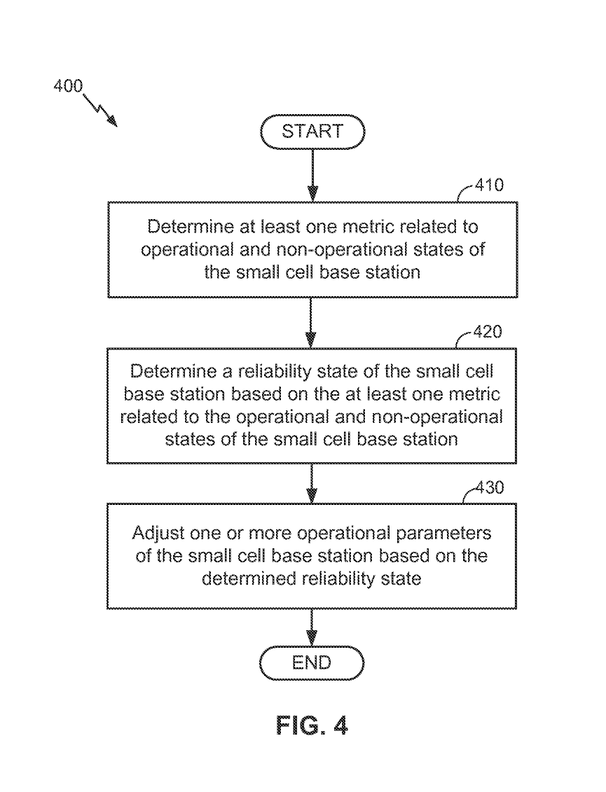

FIG. 4 is a flow diagram illustrating an example method of adjusting one or more operational parameters of a small cell base station within a wireless network. The method 400 may be performed by, for example, a small cell base station, such as small cell base station 200 in FIG. 2, a macro cell base station, such as macro cell base station 110A in FIG. 1, a server, such as server 170 in FIG. 1, or a network node connected to the small cell base station over the wireless network.

At 410, at least one metric related to operational and non-operational states of a small cell base station, such as small cell base station 110B, 110C, and/or 200, is determined. The at least one metric may be an amount of time the small cell base station is operational, an amount of time the small cell base station is not operational, and/or a number of times the small cell base station switches between the operational and non-operational states. The amount of time the small cell base station is not operational may include an amount of time the small cell base station is powered off or an amount of time the small cell base station is powered on but not providing service. The amount of time the small cell base station is powered off may be weighted based on the time of day and/or the day of the week the small cell base station is powered off

In an embodiment, a metric determiner module, such as metric determiner module 112A, 112B, 232, or 312, may determine the at least one metric related to the operational and non-operational states of the small cell base station. The at least one metric related to the operational and non-operational states of the small cell base station may be determined by the metric determiner module resident on the small cell base station, such as metric determiner module 232 in FIG. 2. Determining the at least one metric related to the operational and non-operational states of the small cell base station may include monitoring, measuring, and optionally storing the at least one metric related to the operation and non-operational states of the small cell base station at the small cell base station. For example, the metric determiner module may monitor the amount of time the small cell base station is operational versus the amount of time it is unavailable for service (e.g., powered down), as well as the number of times it changes state from operational to non-operational.

Alternatively, the at least one metric related to the operational and non-operational states of the small cell base station may be determined by a metric determiner module resident on a different small cell base station. In this case, determining the at least one metric related to the operational and non-operational states of the small cell base station may include receiving and optionally storing the at least one metric related to the operational and non-operational states of the small cell base station at the different small cell base station.

As another alternative, the at least one metric related to the operation and non-operational states of the small cell base station may be determined by a metric determiner module resident on a macro cell base station, such as metric determiner module 112A in FIG. 1. Consequently, determining the at least one metric related to the operational and non-operational states of the small cell base station may include receiving and optionally storing the at least one metric related to the operational and non-operational states of the small cell base station at the macro cell base station.

As yet another alternative, the at least one metric related to the operation and non-operational states of the small cell base station may be determined by the metric determiner module resident on a central small cell controller, such as metric determiner module 312 in FIG. 3. In this case, determining the at least one metric related to the operation and non-operational states of the small cell base station may include receiving and optionally storing the at least one metric related to the operational and non-operational states of the small cell base station at the central small cell controller.

At 420, a reliability state of the small cell base station is determined based on the at least one metric related to the operational and non-operational states of the small cell base station. In an embodiment, a reliability determiner module, such as reliability determiner module 114A, 114B, 234, or 314, may determine the at least one metric related to the operational and non-operational states of the small cell base station. The reliability determiner module may determine the reliability state of the small cell base station by comparing the at least one metric to one or more thresholds and determining whether or not the small cell base station is reliable or not based on the comparison. For example, if the small cell base station is powered off 30% of the time, it may not be a suitable cell for extended coverage.

At 430, one or more operational parameters of the small cell base station are adjusted based on the determined reliability state. In an embodiment, a parameter adjuster module, such as parameter adjuster module 116A, 116B, 236, or 316, may adjust the one or more operational parameters of the small cell base station based on the determined reliability state.

If the small cell base station is determined to be in a state of unreliability (at 420), adjusting the one or more operational parameters at 430 may include adjusting the one or more operational parameters to limit an impact of the small cell base station on a local self-organizing network. Alternatively, adjusting the one or more operational parameters at 430 may include adjusting the one or more operational parameters to bias handover against the small cell base station based on determining that the small cell base station is in the state of unreliability.

If the small cell base station is determined to be in a state of reliability, adjusting the one or more operational parameters at 430 may include adjusting the one or more operational parameters to bias handover towards the small cell base station based on determining that the small cell base station is in the state of reliability.

In an aspect, the one or more operational parameters may include one or more of a transmit power, an access mode, or one or more mobility parameters. In another aspect, the one or more operational parameters may relate to one or more of inclusion of a cell operated by the small cell base station in an NRT, establishment of a network interface between the small cell base station and a node in the wireless network, inclusion of a cell operated by the small cell base station in a cell blacklist, and/or determination of whether or not to trigger handover procedures towards a cell operated by the small cell base station.

In yet another aspect, the one or more operational parameters may affect measurement procedures performed on signals from the small cell base station by mobile devices. In such an aspect, the one or more operational parameters may relate to a cell individual offset, measurement thresholds, and/or measurement reporting triggers.

In another aspect, the one or more operational parameters may affect operation of the small cell base station in an open, hybrid, or restricted access mode. In such an aspect, the small cell base station may revert to an open or hybrid mode based on a subsequent command. The command may come from a user, Operations Administration and Maintenance (OAM), the expiration of a timer, internal proprietary behavior, or the like. Alternatively, the small cell base station may revert to the open or hybrid mode based on expiration of a timer.

As noted above, where the flow illustrated in FIG. 4 is performed by a parameter adjuster module at a macro cell base station or central small cell controller in communication with the small cell base station over the wireless network, determining the at least one metric at 410 may include the parameter adjuster module receiving the at least one metric from the small cell base station. In that case, adjusting the one or more operational parameters at 430 may include the parameter adjuster module calculating one or more new operational parameters and sending the values for the one or more operational parameters to the small cell base station. Alternatively, where the parameter adjuster module is implemented on the small cell base station, the parameter adjuster module may calculate the new parameters and instruct the affected components to switch to the new parameters.

Determining the reliability state of the small cell base station at 430 may be based on one or more absolute criteria or one or more relative criteria depending on a comparison of two or more local small cell base stations.

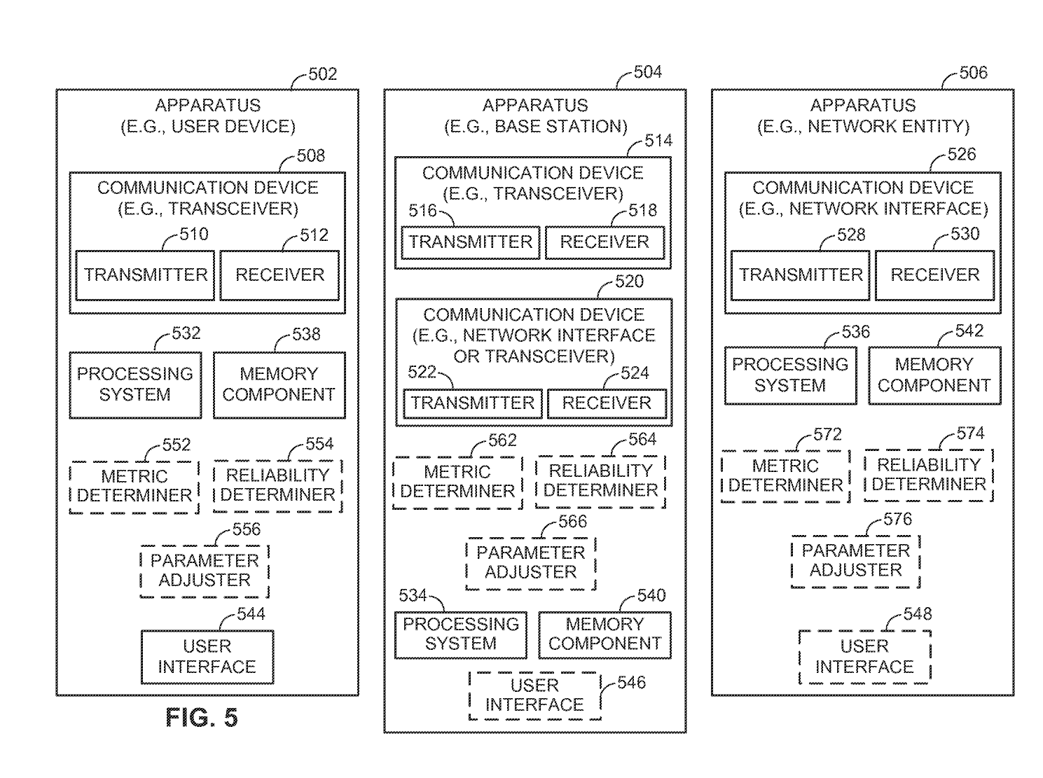

FIG. 5 illustrates several sample components (represented by corresponding blocks) that may be incorporated into an apparatus 502, an apparatus 504, and an apparatus 506 (corresponding to, for example, a user device, a base station, such as macro cell base station 110A in FIG. 1 or small cell base station 200 in FIG. 2, and a network entity, such as server 170 in FIG. 1, respectively) to support the adjustment of one or more operational parameters of a small cell base station as taught herein. It will be appreciated that these components may be implemented in different types of apparatuses in different implementations (e.g., in an ASIC, in an SoC, etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The apparatus 502 and the apparatus 504 each include at least one wireless communication device (represented by the communication devices 508 and 514 (and the communication device 520 if the apparatus 504 is a relay)) for communicating with other nodes via at least one designated RAT. Communication device 508 includes at least one transmitter (represented by the transmitter 510) for transmitting and encoding signals (e.g., messages, indications, information, and so on) and at least one receiver (represented by the receiver 512) for receiving and decoding signals (e.g., messages, indications, information, pilots, and so on). Similarly, communication device 514 includes at least one transmitter (represented by the transmitter 516) for transmitting signals (e.g., messages, indications, information, pilots, and so on) and at least one receiver (represented by the receiver 518) for receiving signals (e.g., messages, indications, information, and so on). If the apparatus 504 is a base station, each communication device 520 may include at least one transmitter (represented by the transmitter 522) for transmitting signals (e.g., messages, indications, information, pilots, and so on) and at least one receiver (represented by the receiver 524) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. A wireless communication device (e.g., one of multiple wireless communication devices) of the apparatus 504 may also comprise a Network Listen Module (NLM) or the like for performing various measurements.

The apparatus 506 (and the apparatus 504 if it is not a relay station) includes at least one communication device (represented by the communication device 526 and, optionally, 520) for communicating with other nodes. For example, the communication device 526 may comprise a network interface that is configured to communicate with one or more network entities via a wire-based or wireless backhaul. In some aspects, the communication device 526 may be implemented as a transceiver configured to support wire-based or wireless signal communication. This communication may involve, for example, sending and receiving: messages, parameters, or other types of information. Accordingly, in the example of FIG. 5, the communication device 526 is shown as comprising a transmitter 528 and a receiver 530. Similarly, if the apparatus 504 is not a relay station, the communication device 520 may comprise a network interface that is configured to communicate with one or more network entities via a wire-based or wireless backhaul. As with the communication device 526, the communication device 520 is shown as comprising a transmitter 522 and a receiver 524.

The apparatuses 502, 504, and 506 also include other components that may be used in conjunction with the adjustment of the one or more operational parameters of a small cell base station as taught herein. The apparatus 502 may include a processing system 532 for providing functionality relating to, for example, user device operations to support determining at least one metric related to operational and non-operational states of a small cell base station, determining a reliability state of the small cell base station, and adjusting one or more operational parameters of the small cell base station based on the determined reliability state as taught herein, and for providing other processing functionality. The apparatus 504 may include a processing system 534 for providing functionality relating to, for example, base station operations to support determining at least one metric related to operational and non-operational states of the apparatus 504, determining a reliability state of the apparatus 504, and adjusting one or more operational parameters of the apparatus 504 based on the determined reliability state as taught herein, and for providing other processing functionality. The apparatus 506 may include a processing system 536 for providing functionality relating to, for example, network entity operations to support determining at least one metric related to operational and non-operational states of a small cell base station, determining a reliability state of the small cell base station, and adjusting one or more operational parameters of the small cell base station based on the determined reliability state as taught herein, and for providing other processing functionality.

The apparatuses 502, 504, and 506 include memory components 538, 540, and 542 (e.g., each including a memory device), respectively, for maintaining information (e.g., information indicative of reserved resources, thresholds, parameters, and so on). In addition, the apparatuses 502, 504, and 506 include user interface devices 544, 546, and 548, respectively, for providing indications (e.g., audible and/or visual indications) to a user and/or for receiving user input (e.g., upon user actuation of a sensing device such a keypad, a touch screen, a microphone, and so on).

For convenience, the apparatuses 502, 504, and/or 506 are shown in FIG. 5 as including various components that may be configured according to the various examples described herein. It will be appreciated, however, that the illustrated blocks may have different functionality in different designs.

For example, apparatus 502 may include a metric determiner module 552, such as metric determiner module 112B in FIG. 1, a reliability determiner module 554, such as reliability determiner module 114B in FIG. 1, and a parameter adjuster module 556, such as parameter adjuster module 116B in FIG. 1. Apparatus 504 may include a metric determiner module 562, such as metric determiner module 112A in FIG. 1, a reliability determiner module 564, such as reliability determiner module 114A in FIG. 1, and a parameter adjuster module 566, such as parameter adjuster module 116A in FIG. 1. Apparatus 506 may include a metric determiner module 572, such as metric determiner module 312 in FIG. 3, a reliability determiner module 574, such as reliability determiner module 314 in FIG. 3, and a parameter adjuster module 576, such as parameter adjuster module 316 in FIG. 3.

The components of FIG. 5 may be implemented in various ways. In some implementations, the components of FIG. 5 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 508, 532, 538, and 544 may be implemented by processor and memory component(s) of the apparatus 502 (e.g., by execution of appropriate code and/or by appropriate configuration of processor components). Similarly, some or all of the functionality represented by blocks 514, 520, 534, 540, and 546 may be implemented by processor and memory component(s) of the apparatus 504 (e.g., by execution of appropriate code and/or by appropriate configuration of processor components). Also, some or all of the functionality represented by blocks 526, 536, 542, and 548 may be implemented by processor and memory component(s) of the apparatus 506 (e.g., by execution of appropriate code and/or by appropriate configuration of processor components).

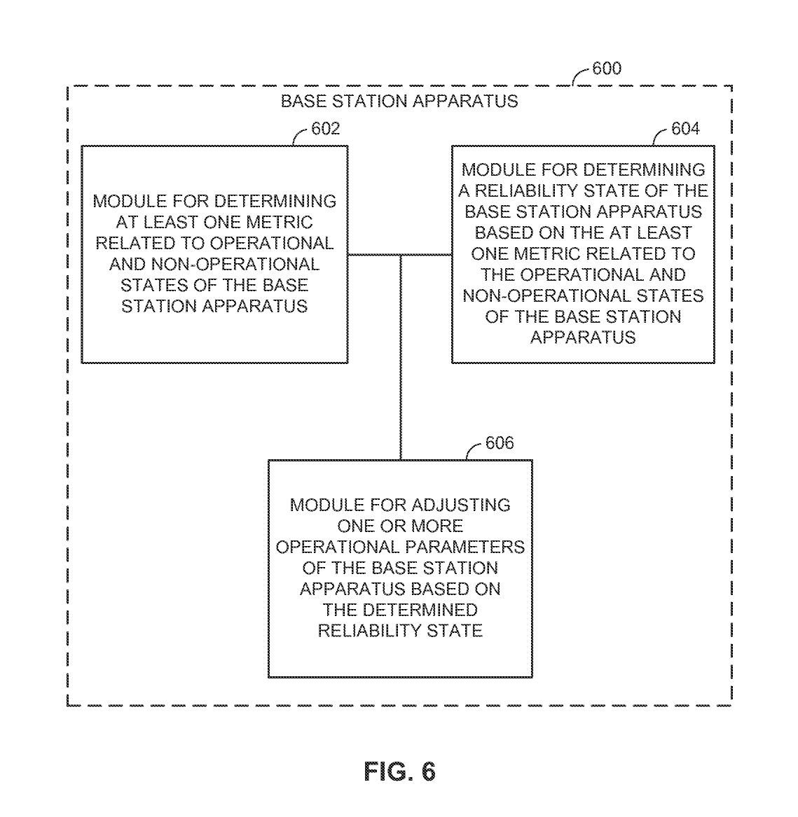

FIG. 6 illustrates an example base station apparatus 600 represented as a series of interrelated functional modules. The base station apparatus 600 may correspond to small cell base station 200 in FIG. 2 and/or apparatus 504 in FIG. 5. A module for determining 602 may correspond at least in some aspects to, for example, a processing system, such as processor 222 in FIG. 2 or processing system 534 or processing system 536 in FIG. 5, or a communication device, such as network interface 210 in FIG. 2 or receiver 530 in FIG. 5, as discussed herein. A module for determining 604 may correspond at least in some aspects to, for example, a processing system, such as processor 222 in FIG. 2 or processing system 534 or processing system 536 in FIG. 5, as discussed herein. A module for adjusting 606 may correspond at least in some aspects to, for example, a processing system, such as processor 222 in FIG. 2 or processing system 534 or processing system 536 in FIG. 5, or a communication device, such as network interface 210 in FIG. 2 or transmitter 528 in FIG. 5, as discussed herein.

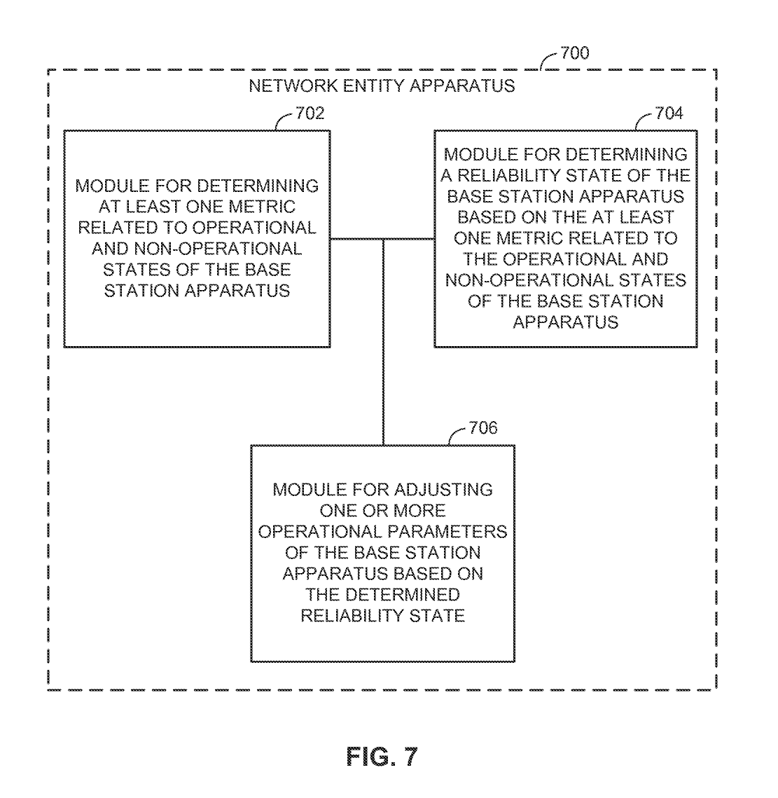

FIG. 7 illustrates an example base station apparatus 700 represented as a series of interrelated functional modules. The network entity apparatus 700 may correspond to the server 300 in FIG. 3 and/or apparatus 506 in FIG. 5, for example. A module for determining 702 may correspond at least in some aspects to, for example, a processing system, such as processor 301 in FIG. 3 or processing system 536 in FIG. 5, or a communication device, such as network access ports 304 in FIG. 3 or receiver 530 in FIG. 5, as discussed herein. A module for determining 704 may correspond at least in some aspects to, for example, a processing system, such as processor 301 in FIG. 3 or processing system 536 in FIG. 5, as discussed herein. A module for adjusting 706 may correspond at least in some aspects to, for example, a processing system, such as processor 301 in FIG. 3 or processing system 536 in FIG. 5, and/or a communication device, such as network access ports 304 in FIG. 3 or transmitter 528 in FIG. 5, as discussed herein.

The functionality of the modules of FIGS. 6 and 7 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIGS. 6 and 7, as well as other components and functions described herein, may be implemented using any suitable means. Such means also may be implemented, at least in part, using corresponding structure as taught herein. For example, the components described above in conjunction with the “module for” components of FIGS. 6 and 7 also may correspond to similarly designated “means for” functionality. Thus, in some aspects one or more of such means may be implemented using one or more of processor components, integrated circuits, or other suitable structure as taught herein.

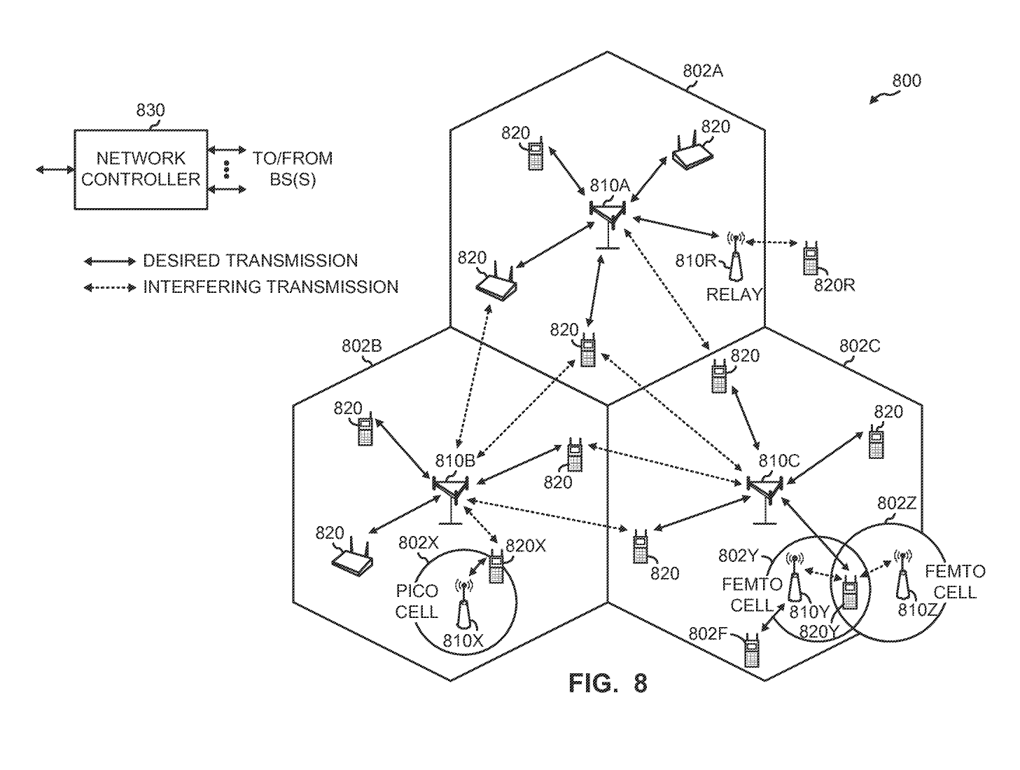

FIG. 8 illustrates an example communication system environment in which the aspects related to the adjustment of one or more operational parameters of a small cell based on small cell reliability described herein may be incorporated. The wireless communication system 800, which will be described at least in part as an LTE network for illustration purposes, includes a number of eNBs 810A-C and other network entities. Each of the eNBs 810A-C provides communication coverage for a particular geographic area, such as macro cell or small cell coverage areas.

In the illustrated example, the eNBs 810A, 810B, and 810C are macro cell eNBs for the macro cells 802A, 802B, and 802C, respectively. The macro cells 802A, 802B, and 802C may cover a relatively large geographic area (e.g., several kilometers in radius) and may allow unrestricted access by UEs with service subscription. The eNB 810X is a particular small cell eNB referred to as a pico cell eNB for the pico cell 802X. The pico cell 802X may cover a relatively small geographic area and may allow unrestricted access by UEs with service subscription. The eNBs 810Y and 810Z are particular small cells referred to as femto cell eNBs for the femto cells 802Y and 802Z, respectively. The femto cells 802Y and 802Z may cover a relatively small geographic area (e.g., a home) and may allow unrestricted access by UEs (e.g., when operated in an open access mode) or restricted access by UEs having association with the femto cell (e.g., UEs in a Closed Subscriber Group (CSG), UEs for users in the home, etc.), as discussed in more detail below.

The wireless communication system 800 also includes a relay station 810R. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs (e.g., a mobile hotspot). In the example shown in FIG. 8, the relay station 81OR communicates with the eNB 810A and a UE 820R in order to facilitate communication between the eNB 810A and the UE 820R. A relay station may also be referred to as a relay eNB, a relay, etc.

The wireless communication system 800 is a heterogeneous network in that it includes eNBs of different types, including macro eNBs, pico eNBs, femto eNBs, relays, etc. As discussed in more detail above, these different types of eNBs may have different transmit power levels, different coverage areas, and different impacts on interference in the wireless communication system 800. For example, macro eNBs may have a relatively high transmit power level whereas pico eNBs, femto eNBs, and relays may have a lower transmit power level (e.g., by a relative margin, such as a 10 dBm difference or more).

Returning to FIG. 8, the wireless communication system 800 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. Unless otherwise noted, the techniques described herein may be used for both synchronous and asynchronous operation.

A network controller 830 may couple to a set of eNBs and provide coordination and control for these eNBs. The network controller 830 may communicate with the eNBs 810A-C via a backhaul. The eNBs 810 may also communicate with one another, e.g., directly or indirectly via a wireless or wireline backhaul.

As shown, the UEs 820 may be dispersed throughout the wireless communication system 800, and each UE may be stationary or mobile, corresponding to, for example, a cellular phone, a personal digital assistant (PDA), a wireless modem, a wireless communication device, a handheld device, a laptop computer, a cordless phone, a wireless local loop (WLL) station, or other mobile entities. In FIG. 8, a solid line with double arrows indicates desired transmissions between a UE and a serving eNB, which is an eNB designated to serve the UE on the downlink and/or uplink. A dashed line with double arrows indicates potentially interfering transmissions between a UE and an eNB. For example, UE 820Y may be in proximity to femto eNBs 810Y, 810Z. Uplink transmissions from UE 820Y may interfere with femto eNBs 810Y, 810Z. Uplink transmissions from UE 820Y may jam femto eNBs 810Y, 810Z and degrade the quality of reception of other uplink signals to femto eNBs 810Y, 810Z.

Small cell eNBs such as the pico cell eNB 810X and femto eNBs 810Y, 810Z may be configured to support different types of access modes. For example, in an open access mode, a small cell eNB may allow any UE to obtain any type of service via the small cell. In a restricted (or closed) access mode, a small cell may only allow authorized UEs to obtain service via the small cell. For example, a small cell eNB may only allow UEs (e.g., so called home UEs) belonging to a certain subscriber group (e.g., a CSG) to obtain service via the small cell. In a hybrid access mode, alien UEs (e.g., non-home UEs, non-CSG UEs) may be given limited access to the small cell. For example, a macro UE that does not belong to a small cell's CSG may be allowed to access the small cell only if sufficient resources are available for all home UEs currently being served by the small cell.

By way of example, femto eNB 810Y may be an open-access femto eNB with no restricted associations to UEs. The femto eNB 810Z may be a higher transmission power eNB initially deployed to provide coverage to an area. Femto eNB 810Z may be deployed to cover a large service area. Meanwhile, femto eNB 810Y may be a lower transmission power eNB deployed later than femto eNB 810Z to provide coverage for a hotspot area (e.g., a sports arena or stadium) for loading traffic from either or both eNB 810C, eNB 810Z.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

In view of the descriptions and explanations above, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor (e.g., cache memory).

Accordingly, it will also be appreciated, for example, that certain aspects of the disclosure can include a computer-readable medium embodying a method for adjusting one or more operational parameters of a small cell based on small cell reliability.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of adjusting one or more operational parameters of a small cell base station within a wireless network, comprising:
determining at least one metric related to operational and non-operational states of a small cell base station;
determining a reliability state of the small cell base station based on the at least one metric related to the operational and non-operational states of the small cell base station; and
adjusting the one or more operational parameters of the small cell base station based on the determined reliability state of the small cell base station.

2. The method of claim 1, wherein the at least one metric related to the operational and non-operational states of the small cell base station comprises an amount of time a small cell base station is operational, an amount of time the small cell base station is not operational, and/or a number of times the small cell base station switches between the operational and non-operational states.

3. The method of claim 2, wherein the amount of time the small cell base station is not operational comprises an amount of time the small cell base station is powered off or an amount of time the small cell base station is powered on but not providing service.

4. The method of claim 3, wherein the amount of time the small cell base station is powered off is weighted based on a time of day and/or a day of the week that the small cell base station is powered off.

5. The method of claim 1, wherein the one or more operational parameters comprise one or more of a transmit power, an access mode, one or more mobility parameters, or any combination thereof.

6. The method of claim 1, wherein determining the reliability state of the small cell base station comprises determining that the small cell base station is in a state of unreliability.

7. The method of claim 6, wherein the adjusting comprises:
adjusting the one or more operational parameters of the small cell base station to limit an impact of the small cell base station on a local self-organizing network based on determining that the small cell base station is in the state of unreliability.

8. The method of claim 6, wherein the adjusting comprises:
adjusting the one or more operational parameters to bias handover against the small cell base station based on determining that the small cell base station is in the state of unreliability.

9. The method of claim 1, wherein determining the reliability state of the small cell base station comprises determining that the small cell base station is in a state of reliability.

10. The method of claim 9, wherein the adjusting comprises:
adjusting the one or more operational parameters to bias handover towards the small cell base station based on determining that the small cell base station is in the state of reliability.

11. The method of claim 1, wherein the one or more operational parameters relate to one or more of:
inclusion of a cell operated by the small cell base station in a neighbor relation table (NRT);
establishment of a network interface between the small cell base station and a node in the wireless network;
inclusion of a cell operated by the small cell base station in a cell blacklist;
determination of whether or not to trigger handover procedures towards a cell operated by the small cell base station, or any combination thereof.

12. The method of claim 1, wherein the one or more operational parameters affect measurement procedures performed on signals from the small cell base station by mobile devices.

13. The method of claim 1, wherein the one or more operational parameters relate to a cell individual offset, measurement thresholds, measurement reporting triggers, or any combination thereof.

14. The method of claim 1, wherein the one or more operational parameters affect operation of the small cell base station in a restricted access mode.

15. The method of claim 14, wherein the small cell base station reverts to an open mode based on a subsequent command.

16. The method of claim 14, wherein the small cell base station reverts to an open mode based on expiration of a timer.

17. The method of claim 1, wherein determining the at least one metric related to the operational and non-operational states of the small cell base station and determining the reliability state of the small cell base station are performed by the small cell base station, a small cell base station neighboring the small cell base station, a macro cell base station in communication with the small cell base station, a macro cell base station neighboring the macro cell base station in communication with the small cell base station, or a central small cell base station controller.

18. The method of claim 17, wherein determining the at least one metric related to the operational and non-operational states of the small cell base station is performed by the macro cell base station in communication with the small cell base station, the macro cell base station neighboring the macro cell base station in communication with the small cell base station, or the central small cell base station controller receiving the at least one metric from the small cell base station.

19. The method of claim 18, wherein adjusting the one or more operational parameters is performed by the macro cell base station in communication with the small cell base station, the macro cell base station neighboring the macro cell base station in communication with the small cell base station, or the central small cell base station controller sending values for the one or more operational parameters to the small cell base station.

20. The method of claim 1, wherein determining the reliability state of the small cell base station is based on one or more absolute criteria or one or more relative criteria depending on a comparison of two or more local small cell base stations.

21. An apparatus for adjusting one or more operational parameters of a small cell base station within a wireless network, comprising:
at least one processor configured to determine at least one metric related to operational and non-operational states of a small cell base station, to determine a reliability state of the small cell base station based on the at least one metric related to the operational and non-operational states of the small cell base station, and to adjust the one or more operational parameters of the small cell base station based on the determined reliability state of the small cell base station; and
a memory coupled to the at least one processor to store the at least one metric related to the operational and non-operational states of the small cell base station.

22. The apparatus of claim 21, wherein the at least one metric related to the operational and non-operational states of the small cell base station comprises an amount of time a small cell base station is operational, an amount of time the small cell base station is not operational, and/or a number of times the small cell base station switches between the operational and non-operational states.

23. The apparatus of claim 21, wherein the one or more operational parameters comprise one or more of a transmit power, an access mode, one or more mobility parameters, or any combination thereof.

24. The apparatus of claim 21, wherein the one or more operational parameters relate to one or more of:
inclusion of a cell operated by the small cell base station in a neighbor relation table (NRT);
establishment of a network interface between the small cell base station and a node in the wireless network;
inclusion of a cell operated by the small cell base station in a cell blacklist;
determination of whether or not to trigger handover procedures towards a cell operated by the small cell base station, or any combination thereof.

25. The apparatus of claim 21, wherein the one or more operational parameters affect measurement procedures performed on signals from the small cell base station by mobile devices.

26. The apparatus of claim 21, wherein the one or more operational parameters relate to a cell individual offset, measurement thresholds, measurement reporting triggers, or any combination thereof.

27. The apparatus of claim 21, wherein the one or more operational parameters affect operation of the small cell base station in a restricted access mode.

28. The apparatus of claim 21, wherein determination of the reliability state of the small cell base station is based on one or more absolute criteria or one or more relative criteria depending on a comparison of two or more local small cell base stations.

29. An apparatus for adjusting one or more operational parameters of a small cell base station within a wireless network, comprising:
means for determining at least one metric related to operational and non-operational states of a small cell base station;
means for determining a reliability state of the small cell base station based on the at least one metric related to the operational and non-operational states of the small cell base station; and
means for adjusting the one or more operational parameters of the small cell base station based on the determined reliability state of the small cell base station.

30. A non-transitory computer-readable medium for adjusting one or more operational parameters of a small cell base station within a wireless network, comprising:
at least one instruction to determine at least one metric related to operational and non-operational states of a small cell base station;
at least one instruction to determine a reliability state of the small cell base station based on the at least one metric related to the operational and non-operational states of the small cell base station; and
at least one instruction to adjust the one or more operational parameters of the small cell base station based on the determined reliability state of the small cell base station.
